(19) United States
(12) Patent Application Publication
(10) Pub. No.: US 2014/0025712 A1
(43) Pub. Date: Jan. 23, 2014

(54) Global Recently Used Files List

(71) Applicants: Ellen Lizabeth Chisa, Redmond, WA (US); Sunder Nelatur Raman, Redmond, WA (US); Jeffrey Dunn, Seattle, WA (US); Rajesh Ramanathan, Redmond, WA (US)

(72) Inventors: Ellen Lizabeth Chisa, Redmond, WA (US); Sunder Nelatur Raman, Redmond, WA (US); Jeffrey Dunn, Seattle, WA (US); Rajesh Ramanathan, Redmond, WA (US)

(73) Assignee: MICROSOFT CORPORATION, Redmond, WA (US)

(21) Appl. No.: 13/610,169

(22) Filed: Sep. 11, 2012

(30) Foreign Application Priority Data
Jul. 19, 2012 (CA) 2783223

(51) Int. Cl. G06F 17/30

(52) U.S. Cl. 707/827; 707/E17.01

(57) ABSTRACT

A global recently used files list identifies files recently accessed by a user through one or more network services and files accessed by the user that are stored locally on a computing device. In order to generate the global recently used files list, a network recently used files list is retrieved that identifies files that were recently accessed through the one or more network services. Applications may update the network recently used files list each time a user accesses files by way of a network service. The network recently used files list may then be merged with a local recently used files list that identifies recently accessed locally stored files in order to generate the global recently used files list. Applications may update the local recently used files list each time files are accessed that are stored locally on a computing device.

### CROSS REFERENCE TO RELATED APPLICATIONS

This application claims the benefit of Canadian Patent Application No. CA 2,783,223, filed Jul. 19, 2012, entitled “Global Recently Used Files List,” the contents of which are incorporated herein by reference.

### BACKGROUND

Information workers commonly utilize a variety of computing devices in a variety of locations to accomplish their work. For example, an information worker might utilize office productivity applications on a desktop computer while located in their office. The same worker might also utilize a laptop computer for work while traveling. The worker might additionally utilize a tablet device, a smartphone, or another type of mobile computing device at other times and at other locations. In order to work efficiently and productively, this type of worker needs quick access to their files regardless of their location, the type of application they are using, and the type of device they are working on at any given time.

It is with respect to these and other considerations that the disclosure made herein is presented.

### SUMMARY

Concepts and technologies are disclosed herein for generating and displaying a global recently used files list. In particular, through an implementation of the concepts and technologies disclosed herein, a global recently used files list can be generated and displayed that identifies files that were recently accessed by a user using different devices and different applications. Items in the global recently used files list can be selected in order to open the associated file in an appropriate application or to perform other types of functions with respect to the associated file. In this way, an information worker can quickly access their recently used files across all of their devices.

According to one embodiment presented herein, a computing device is configured to generate a global recently used files list. In one embodiment, the global recently used files list identifies files recently accessed by a user through one or more network services and, potentially, one or more files recently accessed by the user that are stored locally on the computing device. In one embodiment, the global recently used files list stores the N most recently accessed files. For instance, the 200 most recently accessed files might be included in the global recently used files list.

In order to generate the global recently used files list, the computing device retrieves a network recently used files list that identifies the files that were recently accessed by the user through the one or more network services. Applications may update the network recently used files list each time the user accesses files by way of a network service. The network recently used files list may then be merged with a local recently used files list that identifies the recently accessed locally stored files in order to generate the global recently used files list. Applications may update the local recently used files list each time a user accesses a file that is stored locally on the computing device.

A user interface may also be displayed that presents the files identified in the global recently used files list. For example, a user interface might be presented that includes items corresponding to the files identified in the global recently used files list. Each item might include the name of the file, an indication of the location of the file, and an icon indicating a type of the file. The user interface might also include a status indicator for showing a status of an operation for retrieving the network recently used files list. Other types of information might also be provided in the user interface. Functionality might also be provided for scrolling through the items in the list.

The user interface might also provide functionality for allowing a user to access the files shown in the user interface. For instance, a user might select one of the items in the user interface in order to open the associated file in an appropriate application program. The user interface might also provide functionality for allowing a user to perform other types of access operations with respect to the files identified in the user interface including, but not limited to, downloading the files, saving the files to a new location, sharing the files with other users, “pinning” the files to a “start” menu or other type of quick access list, or removing the files from the global recently used files list.

According to various embodiments, the user interface is optimized for display on a small screen, such as a display screen in a smart phone or tablet computing device. The optimization for display on a small screen might include, but is not limited to, showing only a portion of the files in the recently used files list and displaying only a portion of each item corresponding to the files identified in the global recently used files list. Other optimizations might also be performed for presenting the recently used files list on a small display.

If a user performs an access of a file stored on a network service, the network recently used files list is updated to reflect the access, regardless of the device that the user is utilizing to perform the access. If a user performs an access of a file stored locally on the computing device, the local recently used files list is updated to reflect the access to the selected file.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of one illustrative operating environment for the various embodiments presented herein;

FIG. 2 is a network diagram showing aspects of the operation of a roaming settings server utilized in various embodiments disclosed herein;

FIG. 3 is a flow diagram showing one illustrative routine for updating a network recently used files list according to one embodiment disclosed herein;

FIG. 4 is a network diagram showing additional details regarding the generation of a global recently used files list according to one embodiment disclosed herein;

FIG. 5 is a flow diagram showing one illustrative routine for generating a global recently used files list according to one embodiment disclosed herein;

FIGS. 6-11 are user interface diagrams showing aspects of one illustrative user interface for presenting and interacting with a global recently used files list;

FIG. 12 is a computer architecture diagram illustrating an illustrative computer hardware and software architecture for a computing system capable of implementing aspects of the embodiments presented herein;

FIG. 13 is a diagram illustrating a distributed computing environment capable of implementing aspects of the embodiments presented herein; and

FIG. 14 is a computer architecture diagram illustrating a computing device architecture capable of implementing aspects of the embodiments presented herein.

### DETAILED DESCRIPTION

The following detailed description is directed to concepts and technologies for generating and displaying a global recently used files list. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for generating and presenting a global recently used files list will be described.

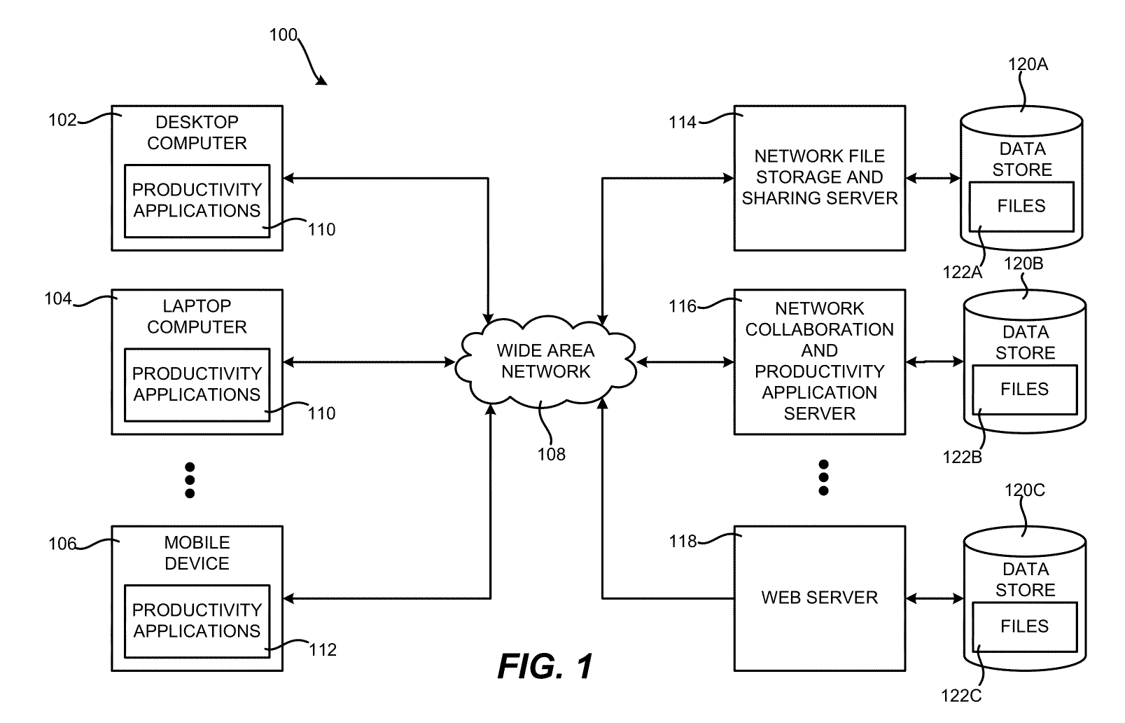

Turning now to FIG. 1, details will be provided regarding an illustrative operating environment and several software components provided by the embodiments presented herein. In particular, FIG. 1 is a network diagram showing aspects of one illustrative operating environment 100 for the various embodiments presented herein. The illustrative operation environment 100 includes a number of client devices, such as the desktop computer 102, laptop computer 104, and mobile device 106 (which may be referred to collectively as the “client devices”), all of which are connected to a wide area network (“WAN”) 108, such as the Internet.

The client devices are configured in one embodiment to execute productivity software applications. For instance, the desktop computer 102 and the laptop computer 104 may be configured to execute the productivity applications 110. The productivity applications 110 may include, but are not limited to, word processing applications, spreadsheet applications, presentation applications, note-taking applications, and other types of office and personal productivity software applications. Specific examples of such applications include, but are not limited to, the OFFICE suite of productivity applications from MICROSOFT CORP., the OPEN OFFICE productivity suite from APACHE, and LOTUS SYMPHONY from IBM. Other types of individual productivity applications and suites of productivity applications might also be utilized.

As shown in FIG. 1, the mobile device 106 is also configured with productivity applications 112. The productivity applications 112 are productivity applications that have been configured for use on a mobile device 106, such as a tablet or a smartphone. Examples of the productivity applications 112 include QUICKOFFICE from GOOGLE, INC. and the OFFICE MOBILE suite of productivity applications from MICROSOFT CORP. Other types of productivity applications 112 configured for use with a mobile device 106 might also be utilized.

According to various embodiments disclosed herein, the productivity applications 110 and 112 are configured to enable the opening and saving of files on remote network services. For example, in one embodiment a network file storage and sharing server 114 is also connected to the WAN 108 and accessible to the client devices. The network file storage and sharing server 114 maintains a data store 120A for storing files 122A. The productivity applications 110 and 112 can store, retrieve, and perform other functions on the files 122A stored in the data store 120A. Examples of the network file storage and sharing server 114 include, but are not limited to the SKYDRIVE file storage system from MICROSOFT CORP., the DROPBOX file storage system from DROPBOX, INC., and the AMAZON CLOUD DRIVE file storage system from AMAZON, INC. Other types of file storage and sharing services from other vendors might also be utilized in the embodiments presented herein.

The productivity applications 110 and 112 might also be configured to enable the opening and saving of files from a network collaboration and productivity application server 116. The network collaboration and productivity application server 116 maintains a data store 120B for storing files 122B, and may also allow users to collaborate on the files 122B. The network collaboration and productivity application server 116 might also allow the client devices to access Web-based versions of the productivity applications 110 through a World Wide Web (“Web”) browser. Examples of the network collaboration and productivity application server 116 include, but are not limited to, GOOGLE DOCS from GOOGLE, INC. and SHAREPOINT ONLINE and OFFICE 365 from MICROSOFT CORP. Other types of network collaboration and productivity application services from other vendors might also be utilized in other embodiments.

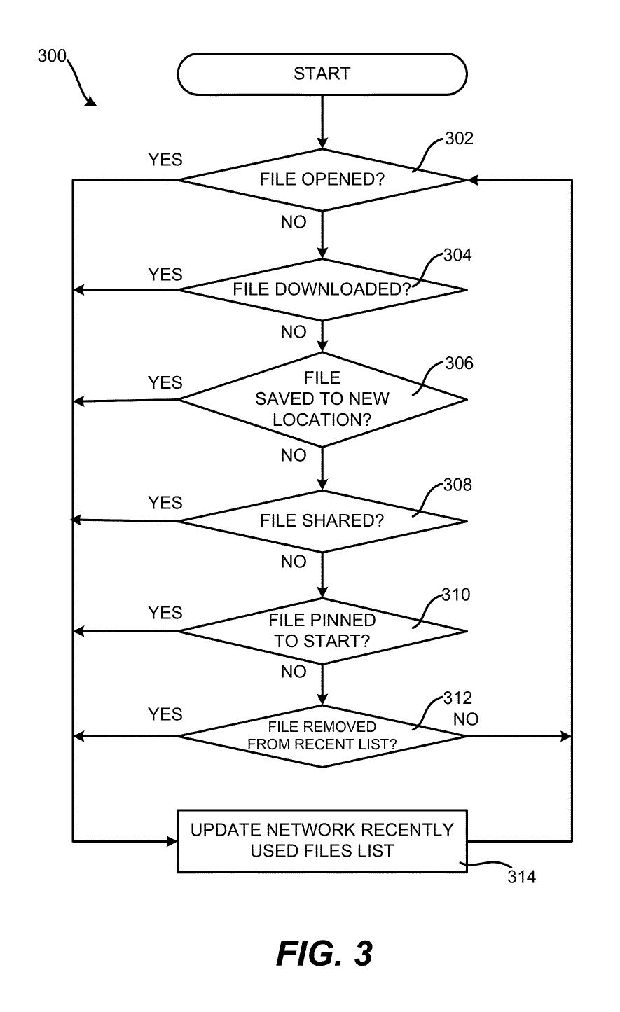

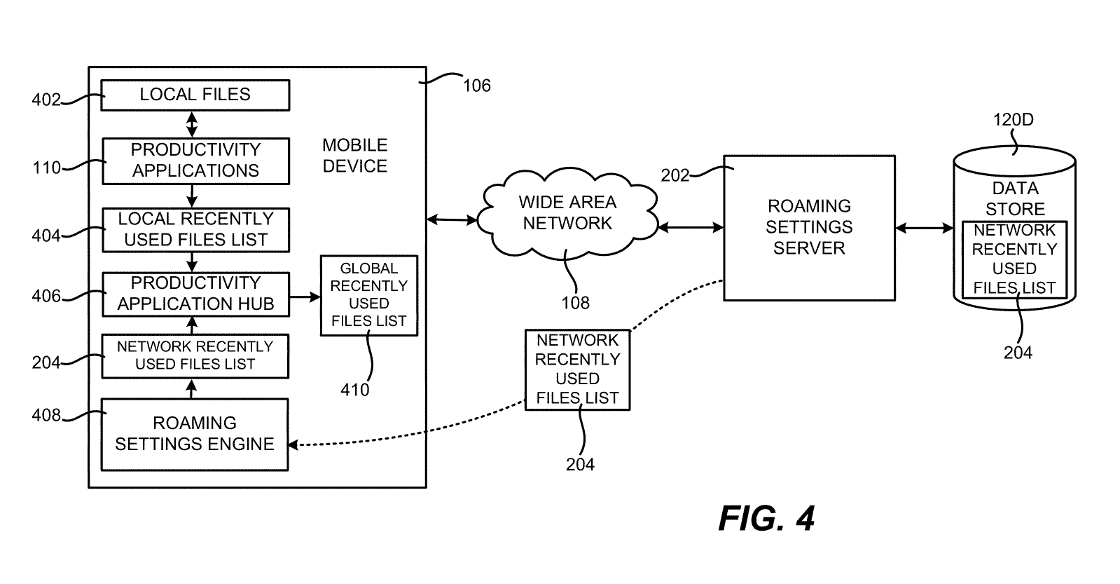

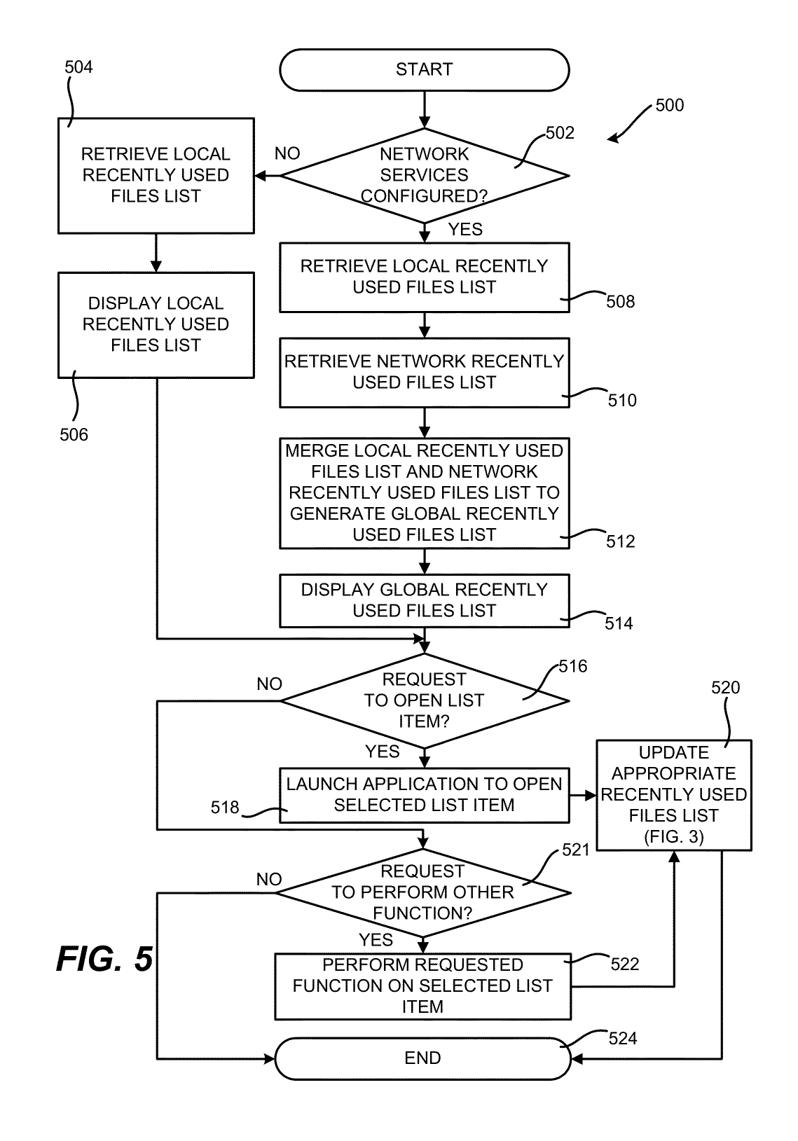

In some embodiments, the productivity applications 110 and 112 also permit the opening of files from a Web server 118. In this regard, the Web server 118 might be connected to a data store 120C storing one or more files 122C. A user of the productivity applications 110 and 112 might request to open a file located at a uniform resource locator (“URL”) serviced by the Web server 118. In response thereto, the productivity applications 110 may request the identified file from the Web server 118 utilizing an appropriate protocol. The requested file may then be retrieved from the Web server 118 and presented to a user for viewing and/or editing in the productivity applications 110 and 112. As will be described in greater detail below with regard to FIG. 3, the productivity applications 110 and 112 might also access files accessible through network services in other ways.

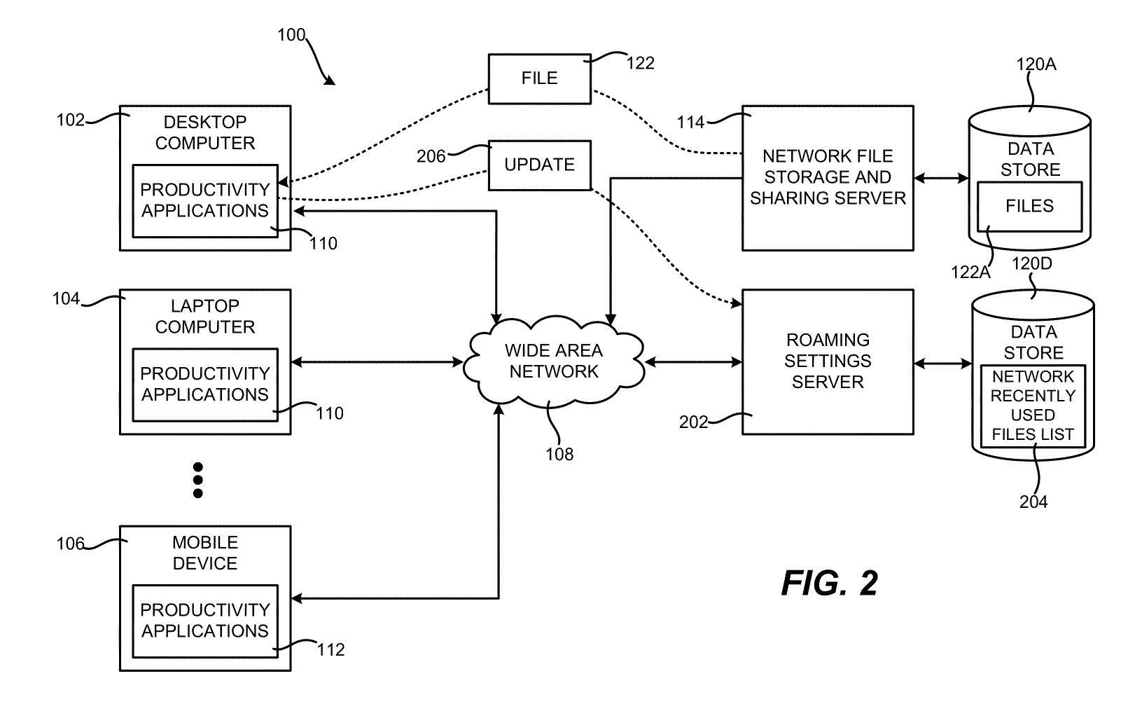

It should be appreciated that the network services and client devices shown in FIG. 1 are merely illustrative and that many other types of network services and client devices might be utilized in the embodiments disclosed herein. It should also be appreciated that while the embodiments disclosed herein are primarily presented in the context of the productivity applications 110 and 112, the embodiments utilized herein might be implemented with any type of application that provides for the retrieval of files from network services. Additionally, it should be appreciated that the network services and client devices have been greatly simplified in FIG. 1 for discussion purposes only. More specific details regarding the configuration of these components will be provided below with regard to FIGS. 2-14.

FIG. 2 is a network diagram showing aspects of the operation of a roaming settings server 202 utilized in various embodiments disclosed herein. As shown in FIG. 2, the roaming settings server 202 is also connected to the WAN 108 and accessible to the client devices. As will be described in further detail herein, the roaming settings server 202 is configured to maintain a per user network recently used files list 204. The network recently used files list 204 may be stored in the data store 120D or another type of appropriate storage device or system.

The network recently used files list 204 includes data identifying the files that have been recently accessed by a user of the client devices by way of one or more network services, such as those shown in FIG. 1 and described above. For example, the network recently used files list 204 might identify the files that a user has recently accessed on the network file storage and sharing server 114, the network collaboration and productivity application server 116, and/or the Web server 118. The network recently used files list 204 might also identify files that were recently accessed by way of other types of network services.

According to embodiments, the network recently used files list 204 might include other data, such as the date and time at which a file was accessed, the type of file that was accessed (e.g. word processing document, spreadsheet document, etc.), the title of the file, and the location at which the file is stored. Other types of information might also be stored in the network recently used files list 204.

FIG. 2 also illustrates one mechanism for updating the network recently used files list 204. In this example, one of the productivity applications 110 has requested a file 122 from the network file storage and sharing server 114. Following the receipt of the file 122, the productivity application transmits an update 206 to the network recently used files list 204. The update 206 indicates that the file 122 has been accessed by a user of the desktop computer 102 and may provide the other information described above, such as the time of the access, the location of the file 122, etc.

In one embodiment, the update 206 also provides information regarding the use of the file 122 by the productivity applications 110. For example, if a user of the desktop computer 102 e-mails the file 122 to another user, the update 206 might include metadata indicating that the file 122 has been e-mailed. This metadata might also be stored in the network recently used files list 204 and provided in the user interfaces described below. In other embodiments, the update 206 might provide other types of metadata describing other uses of a file 122.

In the example shown in FIG. 2, one of the productivity applications 110 executing on the desktop computer 102 has updated the network recently used files list 204. It should be appreciated, however, that the productivity applications 110 executing on the laptop computer 104 and the productivity applications 112 executing on the mobile device 106 might also update the network recently used files list 204 in a similar manner. In this way, the network recently used files list 204 can be updated to identify files accessed by a user through network services by each application and on each device utilized to perform the access. As will be described in greater detail below, the network recently used files list 204 can then be utilized to generate and provide a global recently used files list to a user on the mobile device 106 or another one of the client devices.

It should be appreciated that while a single network recently used files list 204 is illustrated in FIG. 2, multiple such lists might be maintained in other embodiments. For instance, a network recently used files list 204 might be maintained on a per application basis. As an example, one list might be utilized to identify recently accessed word processing documents and a different list might be maintained that identifies recently accessed spreadsheet documents. Individual applications might be configured to update their respective lists on the roaming settings server 202 following the access of a particular file. The network recently used files list 204 might also be stored in other ways using other configurations and technologies.

Referring now to FIG. 3, additional details will be provided regarding the embodiments presented herein for providing a global recently used files list. In particular, FIG. 3 is a flow diagram showing one illustrative routine 300 for updating a network recently used files list 204 according to one embodiment disclosed herein. As discussed briefly above, the productivity applications 110 and 112 might update the network recently used files list 204 in response to accesses of files through network services.

The routine 300 shown in FIG. 3 illustrates some types of file accesses that might result in the network recently used files list 204 being updated. The network recently used files list 204 might also be updated in response to other types of accesses. Additionally, while FIG. 3 describes the network recently used files list 204 being updated by the productivity applications 110 and 112, other applications and services might also update the network recently used files list 204. For instance, the network services described above with regard to FIG. 1, and others, might update the network recently used files list 204 following a file access.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 300 begins at operation 302, where one of the productivity applications 110 or 112 determines whether a file has been opened by way of a network service. If so, the routine 300 proceeds from operation 302 to operation 314, where the network recently used files list 204 is updated to reflect the file access. For example, an entry may be added to the network recently used files list 204 identifying the file name, time of access, file type, file location, and potentially other information. From operation 314, the routine 300 then proceeds back to operation 302, where another such determination might be made.

If, at operation 302, the productivity application determines that a file has not been opened by way of a network service, the routine 300 proceeds to operation 304. At operation 304, the productivity application determines whether a file has been downloaded from a network service. If so, the routine 300 proceeds from operation 304 to operation 314, where the network recently used files list 204 is updated to reflect the download of the file. If a file has not been downloaded from a network service, the routine 300 then proceeds to operation 306.

At operation 306, the productivity application determines whether a file accessed at a network service has been saved to a new location. If so, the routine 300 proceeds from operation 306 to operation 314, where the network recently used files list 204 is updated to reflect the saving of the file at a new location. For example, an entry might be added to the network recently used files list 204 indicating the name of the file, its new location, type, etc. If a file has not been saved to a new location, the routine 300 proceeds from operation 306 to operation 308.

At operation 308, the productivity application determines whether a file accessed at a network service has been shared with another user. For example, a file might be shared via e-mail or another mechanism. If a file has been shared, the routine 300 proceeds from operation 308 to operation 314, where the network recently used files list 204 is updated to reflect the sharing of the file. For example, the name, location, type, and time at which the file was shared may be added to the network recently used files list 204. If a file has not been shared, the routine 300 proceeds from operation 308 to operation 310.

At operation 310, the productivity application determines whether a file accessed at a network service has been pinned to a “start” menu or other type of quick access file menu. If so, the routine 300 proceeds from operation 310 to operation 314, where the network recently used files list 204 is updated to reflect the identity of the file that was pinned. If a file has not been pinned, the routine 300 proceeds from operation 310 to operation 312.

At operation 312, the productivity application determines whether a file accessed at a network service has been removed from the global recently used files list. If so, the routine 300 proceeds from operation 312 to operation 314, where the network recently used files list 204 is updated to reflect the removal of the file from the global recently used files list. For example, an entry in the network recently used files list 204 corresponding to the removed file may be deleted. From operation 314, the routine 300 proceeds to operation 302, described above, where additional determinations may occur regarding file accesses.

As mentioned above, the file accesses described with regard to FIG. 3 are merely illustrative and other types of file accesses might also result in an update to the network recently used files list 204. An update might add an entry from the list 204, delete an entry from the list 204, modify an entry already existing in the list 204, and/or perform another function. As also mentioned above, updates to the list 204 might be applied by applications executing on the client devices, by network services, and/or by other components and systems.

FIG. 4 is a network diagram showing additional details regarding the generation of a global recently used files list 410 according to one embodiment disclosed herein. As shown in FIG. 4, the client devices (the mobile device 106 in this example) may be configured with a productivity application hub 406. The productivity application hub 406 is a computer program that provides access to functionality provided by the productivity applications 110. For example, in one embodiment disclosed herein, the productivity application hub 406 is configured to generate and present a global recently used files list 410. The global recently used files list 410 identifies files recently accessed by a user of the device through one or more network services and, potentially, one or more local files 402 recently accessed by the user that are stored locally on the computing device. In one embodiment, the global recently used files list 410 identifies the N most recently accessed files. For instance, the 200 most recently accessed files might be included in the global recently used files list 410.

In order to generate the global recently used files list 410, a roaming settings engine 408 executing on the mobile device 106 retrieves the network recently used files list 204 from the roaming settings server 202. The network recently used files list 204 is then merged with a local recently used files list 404 that identifies the recently accessed locally stored files 402 in order to generate the global recently used files list 410. Applications may update the local recently used files list 404 each time a user accesses a file 402 that is stored locally on the mobile device 106. As an example, an e-mail attachment opened on a client device might be identified in the local recently used files list 404.

As will be described in greater detail below, the productivity application hub 406 might also generate and display a user interface that presents the files identified in the global recently used files list 410. For example, a user interface might be presented that includes items corresponding to the files identified in the global recently used files list 410. Each item might include the name of the file, an indication of the location of the file, and an icon indicating a type of the file. The user interface might also include a status indicator for showing a status of an operation for retrieving the network recently used files list. Other types of information might also be provided in the user interface. Functionality might also be provided for scrolling through the items in the list.

The user interface provided by the productivity application hub 406 might also provide functionality for allowing a user to access the files shown in the user interface. For instance, a user might select one of the items in the user interface in order to open the associated file in a productivity application 110. The user interface might also provide functionality for allowing a user to perform other types of access operations with respect to the files identified in the user interface including, but not limited to, downloading the files to the device, saving the files to a new location, sharing the files with other users, “pinning” the files to a “start” menu or other type of quick access list, sharing the files with other users, or removing the files from the global recently used files list.

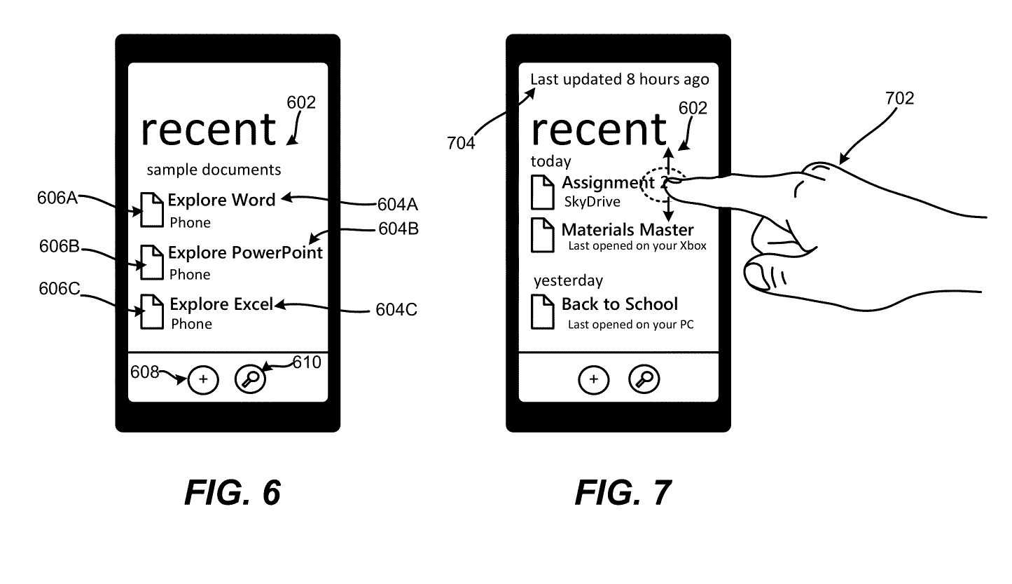

It should be appreciated that while the productivity application hub 406 generates the global recently used files list 410 and presents a user interface for interacting with the list 410 in one embodiment, other components might also perform this functionality. For example, the productivity applications 110 and/or 112 might provide this functionality in other embodiments. Other types of applications, systems, and/or services might also perform these functions in other embodiments. Additional details regarding the generation of the global recently used files list 410 will be provided below with regard to FIG. 5. Additional details regarding the presentation of a user interface for viewing and interacting with the global recently used files list 410 will be provided below with regard to FIGS. 6-11.

FIG. 5 is a flow diagram showing one illustrative routine 500 for generating a global recently used files list 410 according to one embodiment disclosed herein. The routine 500 begins at operation 502, where a client device, the mobile device 106 for instance, determines whether it has been configured for use with any network services, such as those described above with regard to FIG. 1. If no network services have been configured, the client device shows only the files identified in the local recently used files list 404. This occurs at operations 504 and 506.

If the client device has been configured for use with one or more network services, the routine 500 proceeds from operation 502 to operation 508. At operation 508, the productivity application hub 406 retrieves the local recently used files list 404. The routine 500 then proceeds to operation 510, where the roaming settings engine 408 retrieves the network recently used files list 204 from the roaming settings server 202. The roaming settings engine 408 is configured in some embodiments to periodically retrieve the network recently used files list 204 from the roaming settings server 202. For instance, the roaming settings engine 408 might automatically retrieve the network recently used files list 204 every fifteen minutes or other time period. In other embodiments, the network recently used files list 204 is “pushed” to the roaming settings engine 408. The network recently used files list 204 might be provided to the roaming settings engine 408 in other ways in other implementations.

From operation 510, the routine 500 proceeds to operation 512, where the productivity application hub 406 merges the contents of the network recently used files list 204 and the contents of the local recently used files list 404 in order to generate the global recently used files list 410. The files identified in the lists 204 and 404 may be merged such that they may be presented in reverse chronological order by time of file access (i.e. most recently accessed files first). The global recently used files list 410 might also be sorted in other ways, such as by document type or location.

Once the global recently used files list 410 has been generated, the routine 500 proceeds to operation 514, where the productivity application hub 406 displays the global recently used files list 410. As mentioned above, the number of displayed entries might be limited to a predefined number in some embodiments. As also mentioned above, the user interface provided by the productivity application hub 406 might also allow a user to open or otherwise access and interact with files identified in the global recently used files list 410. Several illustrative user interfaces for providing this functionality will be described below with regard to FIGS. 6-11.

If, at operation 516, the productivity application hub 406 determines that a user has requested to open one of the files shown in the list 410, the routine 500 proceeds from operation 516 to operation 518. At operation 518, an appropriate application for opening the selected file is launched in order to open the file in the manner requested by the user. The routine 500 then proceeds from operation 518 to operation 520, where the appropriate list 204 or 404 is updated to reflect the file opened. For instance, if the file is a local file 402, the local recently used files list 404 will be updated. If the file is accessed through a network service, the network recently used files list 204 will be updated.

If a user has not requested to open a file, the routine 500 proceeds from operation 516 to operation 521, where the productivity application hub 406 determines whether the user has requested to perform another type of file access. For instance, as discussed above, a user may request to download a file in the list 410, save a file shown in the list 410 to a new location, share a file in the list 410 with another user, “pin” a file in the list 410 to a “start” menu or another type of quick access list or location, remove a file from the global recently used files list 410, or perform another type of file operation.

If a user of the client device requests to perform another type of function with regard to a file identified in the global recently used files list 410, the routine 500 proceeds from operation 521 to operation 522 where the requested access is performed. From operation 522, the routine 500 proceeds to operation 520, where the appropriate list 204 or 404 is updated to reflect the file access. From operation 520, the routine 500 proceeds to operation 524, where it ends.

FIGS. 6-11 are user interface diagrams showing aspects of one illustrative user interface 602 for presenting and interacting with a global recently used files list 410. It should be appreciated that the user interfaces shown in FIGS. 6-11 are presented by the productivity application hub 406 in one embodiment disclosed herein. Other types of programs might also provide other types of user interfaces, however. For example, the productivity applications 110 executing on the desktop computer 102 and/or the laptop computer 104 might present the global recently used files list 410 in a drop-down menu or other type of user interface. A network services might also present the global recently used files list 410, such as through a Web interface. Other types of user interfaces might also be utilized.

As shown in FIG. 6, the user interface 602 includes items 604A-604C corresponding to items in the global recently used files list 410. Each of the items 604A-604C includes a name of the corresponding file and, in some embodiments, data identifying the location of the file. For instance, in the example shown in FIG. 6, the referenced files are all stored on a phone. In some embodiments, each item 604A-604C also includes an icon that may indicate the type of the corresponding file (e.g. an icon indicating that the file is a word processing document, a spreadsheet document, etc.).

In some embodiments, the items 6-4A-604C also specify the client device at which a corresponding file was last used. For example, an item might indicate that a file was last opened on a desktop computer, a game console, or another device. An example of this functionality is shown in FIG. 7. In order to provide this functionality, data may be collected and stored in the network recently used files list 204 indicating the last device at which each file was opened. This functionality might also be implemented in other ways.

In some embodiments, the user interface 602 includes an icon 610 or other user interface control which, when selected, will allow a user to search for files on the device. The user interface 602 might also include an icon 608 or other user interface control which, when selected, will allow a user to create a new file using one of the productivity applications 110 or 112. The user interface 602 might also include other items and controls not shown in FIG. 6 or the other FIGURES. For instance, the user interface 602 might include one or more user interface controls for filtering the list 410 by document type or in another manner.

FIG. 6 shows a state of the user interface 602 when a user has not yet accessed any files either remotely or locally on the device. Accordingly, in this case, three sample files are referenced by the items 604A-604C. As the user accesses files, the items 604A-604C are moved lower on the list 410. As some point, the items 604A-604C may be removed from the list 410. For instance, the items 604A-604C might be removed from the list 410 after a user has accessed 200 or some other number of files.

As shown in FIG. 7, the user interface 602 provides functionality for allowing a user to scroll through the items in the list 410. As an example, a user might utilize their hand 702 and a touch screen user input device to input a vertical “swiping” gesture. The list shown in the user interface 602 will then scroll appropriately in response to the gesture. Other types of gestures and user input mechanisms might also be utilized that are appropriate to the type of device upon which the productivity application hub 406 is executing.

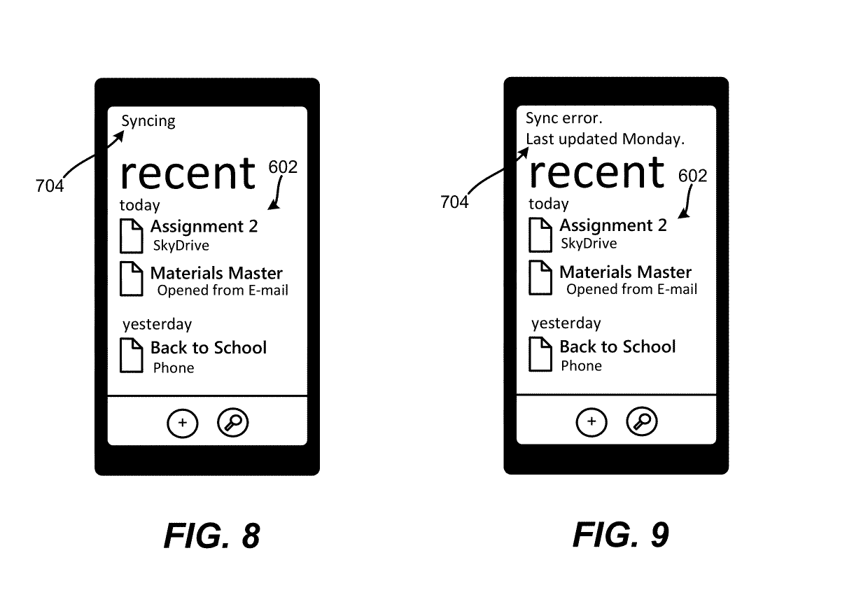

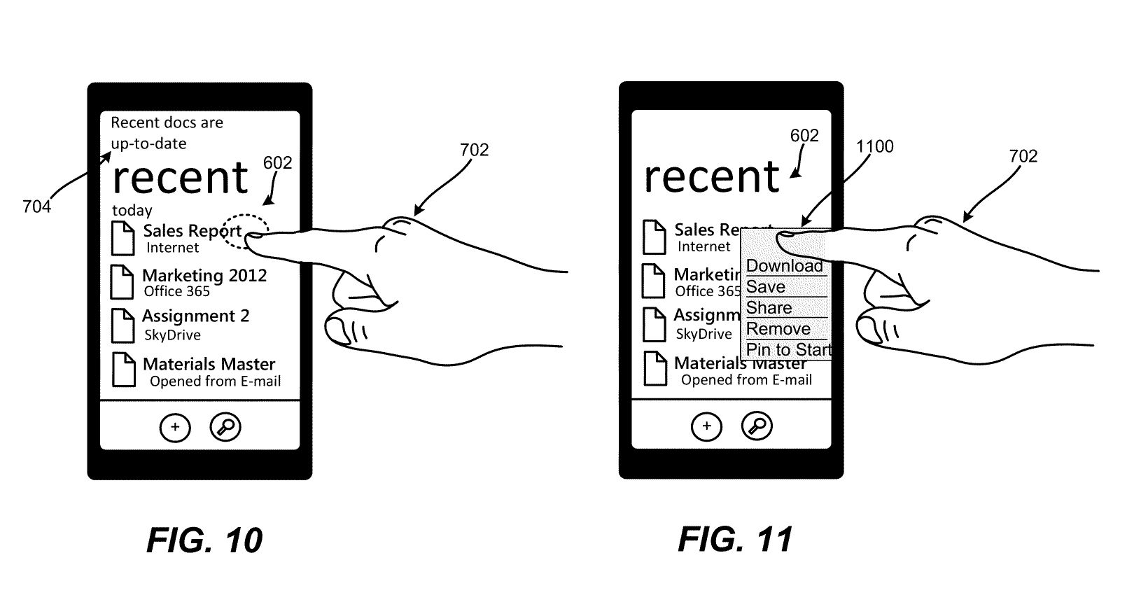

As shown in FIG. 7, the user interface 602 might also include a status indicator 704 showing the status of an operation for retrieving the network recently used files list 204 from the roaming settings server 202. In the example shown in FIG. 7, for instance, the network recently used files list 204 was last retrieved eight hours earlier. While the network recently used files list 204 is being retrieved, the status indicator 704 may be changed to show that syncing is in progress as shown in FIG. 8. If an error occurs during syncing, the status indicator 704 may be updated to show that a synchronization error occurred. The status indicator 704 might also indicate the last time a successful update occurred as shown in FIG. 9. When a successful synchronization of the network recently used files list 204 occurs, the status indicator 704 might be updated to indicate that the list 410 is up to date as shown in FIG. 10.

As also shown in FIG. 10, a user might request to open one of the files referenced by items 604 shown in the user interface 602 by “tapping” the item. As mentioned above, an appropriate application for opening the referenced file may then be executed in order to open the selected file. A user might also perform a “long tap” operation in order to access user interface controls for performing other types of file operations. For example, as shown in FIG. 11, a long tap operation might result in the display of a menu user interface control 1100 for accessing functionality for downloading a file, saving a file to a new location, sharing a file, removing a file from the list 410, and for pinning a file to a start menu or another quick access list or location. Other types of functionality for interacting with files shown in the user interface 602 might also be provided.

It should be appreciated that the user interface 602 shown in FIGS. 6-11 may be optimized for display on a small screen, such as a display screen in a smart phone or tablet computing device. The optimization for display on a small screen might include, but is not limited to, showing only a portion of the files in the global recently used files list 410 and displaying only a portion of each item 604 corresponding to the files identified in the global recently used files list 410. Other optimizations might also be performed for presenting the global recently used files list 410 on a small display screen.

As mentioned briefly above, the user interface 602 shown in FIGS. 6-11 is merely illustrative. Other types and configurations of user interfaces, user interface controls, and input gestures and mechanisms might also be utilized to present the list 410 and to interact with and access the files referenced in the list 410.

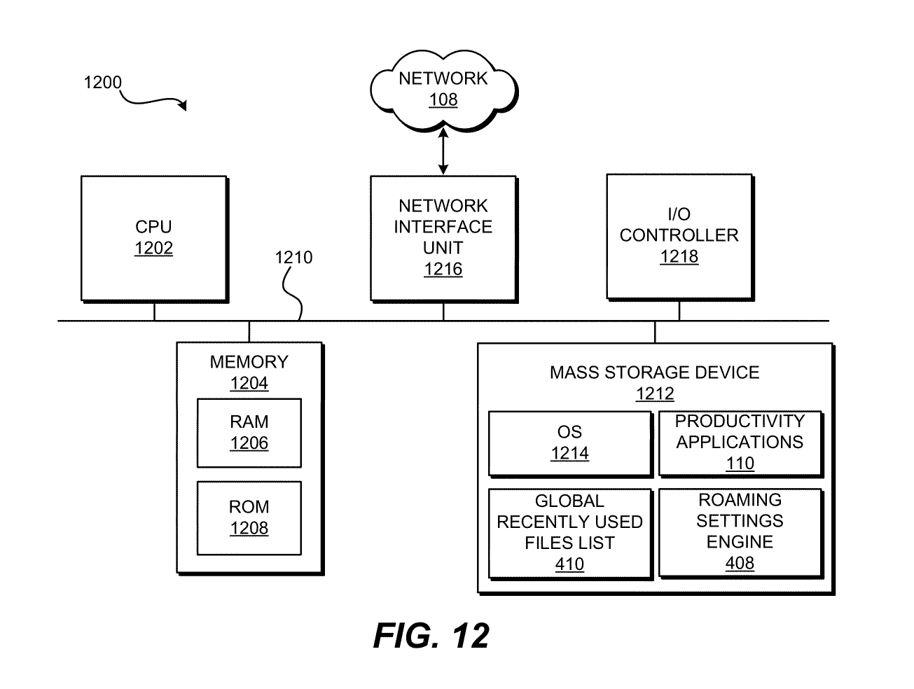

FIG. 12 illustrates an illustrative computer architecture 1200 for a device capable of executing the software components described herein for providing a global recently used files list 410. Thus, the computer architecture 1200 illustrated in FIG. 12 illustrates an architecture for a server computer, mobile phone, personal digital assistant, smart phone, desktop computer, netbook or ultrabook computer, tablet computer, laptop computer, or other type of computing device. The computer architecture 1200 may be utilized to execute any aspects of the software components presented herein.

The computer architecture 1200 illustrated in FIG. 12 includes a central processing unit 1202 (“CPU”), a system memory 1204, including a random access memory 1206 (“RAM”) and a read-only memory (“ROM”) 1208, and a system bus 1210 that couples the memory 1204 to the CPU 1202. A basic input/output system containing the basic routines that help to transfer information between elements within the computer architecture 1200, such as during startup, is stored in the ROM 1208. The computer architecture 1200 further includes a mass storage device 1212 for storing the operating system 1214 and one or more application programs including, but not limited to, the productivity applications 110 and the roaming settings engine 408. The mass storage device 1212 also can also be configured to store the global recently used files list 410 and other data.

The mass storage device 1212 is connected to the CPU 1202 through a mass storage controller (not shown) connected to the bus 1210. The mass storage device 1212 and its associated computer-readable media provide non-volatile storage for the computer architecture 1200. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 1200.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1200. For purposes the claims, the phrase “computer storage medium” and variations thereof, does not include waves, signals, and/or other transitory and/or intangible communication media, per se.

According to various embodiments, the computer architecture 1200 may operate in a networked environment using logical connections to remote computers through a network such as the network 108. The computer architecture 1200 may connect to the network 108 through a network interface unit 1216 connected to the bus 1210. It should be appreciated that the network interface unit 1216 also may be utilized to connect to other types of networks and remote computer systems, such as the servers 114, 116, and 118, for example. The computer architecture 1200 also may include an input/output controller 1218 for receiving and processing input from a number of other devices, including a keyboard, mouse, or electronic stylus (not shown in FIG. 12). Similarly, the input/output controller 1218 may provide output to a display screen, a printer, or other type of output device (also not shown in FIG. 12).

It should be appreciated that the software components described herein may, when loaded into the CPU 1202 and executed, transform the CPU 1202 and the overall computer architecture 1200 from a general-purpose computing system into a special-purpose computing system customized to facilitate the functionality presented herein. The CPU 1202 may be constructed from any number of transistors or other discrete circuit elements, which may individually or collectively assume any number of states. More specifically, the CPU 1202 may operate as a finite-state machine, in response to executable instructions contained within the software modules disclosed herein. These computer-executable instructions may transform the CPU 1202 by specifying how the CPU 1202 transitions between states, thereby transforming the transistors or other discrete hardware elements constituting the CPU 1202.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1200 in order to store and execute the software components presented herein. It also should be appreciated that the computer architecture 1200 may include other types of computing devices, including hand-held computers, embedded computer systems, video game systems, set top boxes, e-readers, personal digital assistants, and other types of computing devices known to those skilled in the art. It is also contemplated that the computer architecture 1200 may not include all of the components shown in FIG. 12, may include other components that are not explicitly shown in FIG. 12, or may utilize an architecture completely different than that shown in FIG. 12.

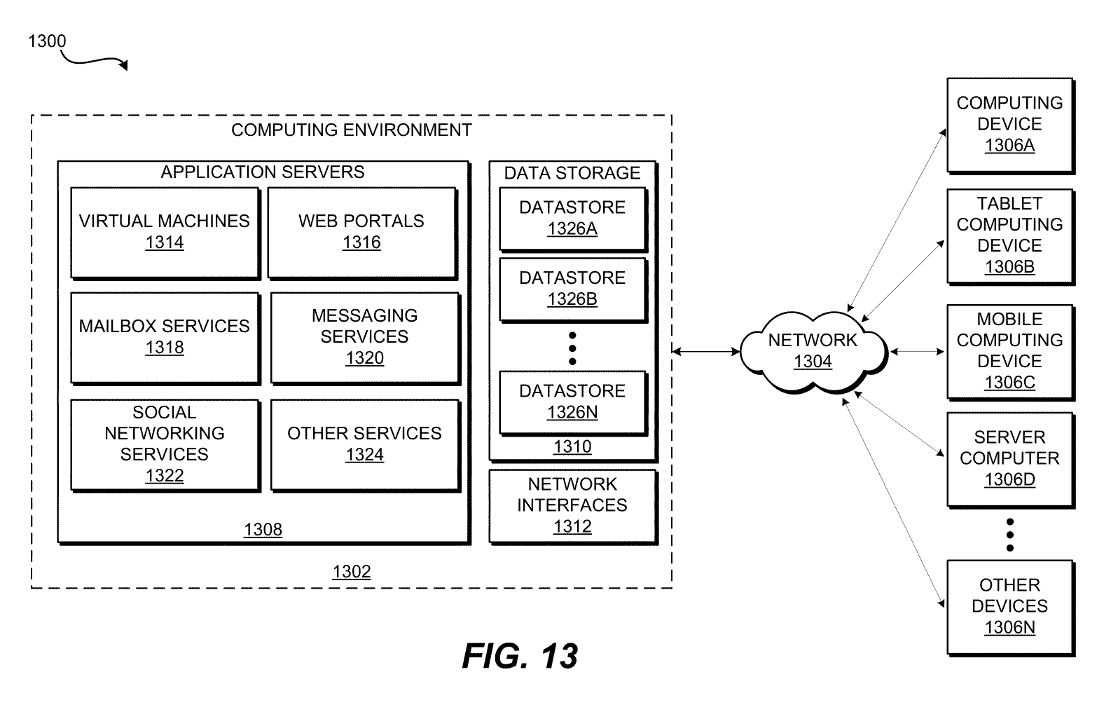

FIG. 13 shows an illustrative distributed computing environment 1300 capable of executing the software components described herein for generating and providing a global recently used files list 410. Thus, the distributed computing environment 1300 illustrated in FIG. 13 can be used to provide the functionality described herein with respect to the mobile device 106, the desktop computer, the laptop computer 104, and the other computer systems described herein. The distributed computing environment 1300 thus may be utilized to execute any aspects of the software components presented herein.

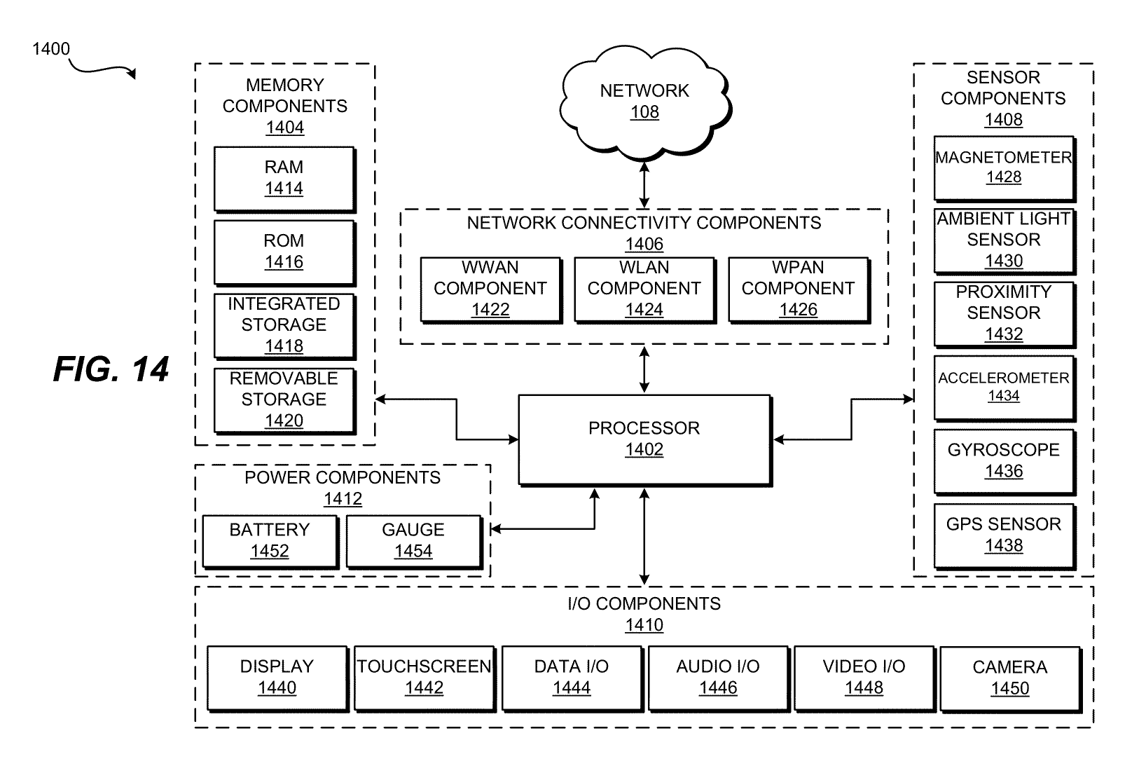

According to various implementations, the distributed computing environment 1300 includes a computing environment 1302 operating on, in communication with, or as part of the network 1304. The network 1304 also can include various access networks. One or more client devices 1306A-1306N (hereinafter referred to collectively and/or generically as “clients 1306”) can communicate with the computing environment 1302 via the network 1304 and/or other connections (not illustrated in FIG. 13). In the illustrated embodiment, the clients 1306 include a computing device 1306A such as a laptop computer, a desktop computer, or other computing device; a slate or tablet computing device (“tablet computing device”) 1306B; a mobile computing device 1306C such as a mobile telephone, a smart phone, or other mobile computing device; a server computer 1306D; and/or other devices 1306N. It should be understood that any number of clients 1306 can communicate with the computing environment 1302. Two example computing architectures for the clients 1306 are illustrated and described herein with reference to FIGS. 12 and 14. It should be understood that the illustrated clients 1306 and computing architectures illustrated and described herein are illustrative, and should not be construed as being limited in any way.

In the illustrated embodiment, the computing environment 1302 includes application servers 1308, data storage 1310, and one or more network interfaces 1312. According to various implementations, the functionality of the application servers 1308 can be provided by one or more server computers that are executing as part of, or in communication with, the network 1304. The application servers 1308 can host various services, virtual machines, portals, and/or other resources. In the illustrated embodiment, the application servers 1308 host one or more virtual machines 1314 for hosting applications or other functionality. According to various implementations, the virtual machines 1314 host one or more applications and/or software modules for providing the functionality described herein for generating and providing a global recently used files list 410. It should be understood that this embodiment is illustrative, and should not be construed as being limiting in any way. The application servers 1308 also host or provide access to one or more Web portals, link pages, Web sites, and/or other information (“Web portals”) 1316.

According to various implementations, the application servers 1308 also include one or more mailbox services 1318 and one or more messaging services 1320. The mailbox services 1318 can include electronic mail (“email”) services. The mailbox services 1318 also can include various personal information management (“PIM”) services including, but not limited to, calendar services, contact management services, collaboration services, and/or other services. The messaging services 1320 can include, but are not limited to, instant messaging services, chat services, forum services, and/or other communication services.

The application servers 1308 also can include one or more social networking services 1322. The social networking services 1322 can include various social networking services including, but not limited to, services for sharing or posting status updates, instant messages, links, photos, videos, recently used files, and/or other information; services for commenting or displaying interest in articles, products, files, blogs, or other resources; and/or other services. In some embodiments, the social networking services 1322 are provided by or include the FACEBOOK social networking service, the LINKEDIN professional networking service, the MYSPACE social networking service, the FOURSQUARE geographic networking service, the YAMMER office colleague networking service, and the like. In other embodiments, the social networking services 1322 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 1322 also can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 1322 are not mentioned herein for the sake of brevity. As such, the above embodiments are illustrative, and should not be construed as being limited in any way.

As shown in FIG. 13, the application servers 1308 also can host other services, applications, portals, and/or other resources (“other resources”) 1324. The other resources 1324 can include, but are not limited to, the services for remote file access and sharing, for maintaining the network recently used files list 204, and for performing other network services. It thus can be appreciated that the computing environment 1302 can provide integration of the concepts and technologies disclosed herein provided herein for generating a global recently used files list 410 with various mailbox, messaging, social networking, and/or other services or resources. For example, the concepts and technologies disclosed herein might be utilized to share the global recently used files list 410 with other users.

As mentioned above, the computing environment 1302 can include the data storage 1310. According to various implementations, the functionality of the data storage 1310 is provided by one or more databases operating on, or in communication with, the network 1304. The functionality of the data storage 1310 also can be provided by one or more server computers configured to host data for the computing environment 1302. The data storage 1310 can include, host, or provide one or more real or virtual datastores 1326A-1326N (hereinafter referred to collectively and/or generically as “datastores 1326” or as a “data store”). The datastores 1326 are configured to host data used or created by the application servers 1308 and/or other data. Although not illustrated in FIG. 13, the datastores 1326 also can host or store the network recently used files list 204.

The computing environment 1302 can communicate with, or be accessed by, the network interfaces 1312. The network interfaces 1312 can include various types of network hardware and software for supporting communications between two or more computing devices including, but not limited to, the clients 1306 and the application servers 1308. It should be appreciated that the network interfaces 1312 also may be utilized to connect to other types of networks and/or computer systems.

It should be understood that the distributed computing environment 1300 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1300 provides the software functionality described herein as a service to the clients 1306. It should be understood that the clients 1306 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 1300 to utilize the functionality described herein for generating a global recently used files list 410.

Turning now to FIG. 14, an illustrative computing device architecture 1400 for a computing device that is capable of executing various software components described herein for generating a global recently used files list 410. The computing device architecture 1400 is applicable to computing devices that facilitate mobile computing due, in part, to form factor, wireless connectivity, and/or battery-powered operation. In some embodiments, the computing devices include, but are not limited to, mobile telephones, tablet devices, slate devices, portable video game devices, and the like. Moreover, the computing device architecture 1400 is applicable to any of the clients 1406 shown in FIG. 13. Furthermore, aspects of the computing device architecture 1400 may be applicable to traditional desktop computers, portable computers (e.g., laptops, notebooks, ultra-portables, and netbooks), server computers, and other computer systems, such as described herein with reference to FIG. 12. For example, the single touch and multi-touch aspects disclosed herein below may be applied to desktop computers that utilize a touchscreen or some other touch-enabled device, such as a touch-enabled track pad or touch-enabled mouse.

The computing device architecture 1400 illustrated in FIG. 14 includes a processor 1402, memory components 1404, network connectivity components 1406, sensor components 1408, input/output components 1410, and power components 1412. In the illustrated embodiment, the processor 1402 is in communication with the memory components 1404, the network connectivity components 1406, the sensor components 1408, the input/output (“I/O”) components 1410, and the power components 1412. Although no connections are shown between the individuals components illustrated in FIG. 14, the components can interact to carry out device functions. In some embodiments, the components are arranged so as to communicate via one or more busses (not shown).

The processor 1402 includes a central processing unit (“CPU”) configured to process data, execute computer-executable instructions of one or more application programs, and communicate with other components of the computing device architecture 1400 in order to perform various functionality described herein. The processor 1402 may be utilized to execute aspects of the software components presented herein and, particularly, those that utilize, at least in part, a touch-enabled input.

In some embodiments, the processor 1402 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“3D”) modeling applications, and the like. In some embodiments, the processor 1402 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some embodiments, the processor 1402 is, or is included in, a system-on-chip (“SoC”) along with one or more of the other components described herein below. For example, the SoC may include the processor 1402, a GPU, one or more of the network connectivity components 1406, and one or more of the sensor components 1408. In some embodiments, the processor 1402 is fabricated, in part, utilizing a package-on-package (“PoP”) integrated circuit packaging technique. Moreover, the processor 1402 may be a single core or multi-core processor.

The processor 1402 may be created in accordance with an ARM architecture, available for license from ARM HOLDINGS of Cambridge, United Kingdom. Alternatively, the processor 1402 may be created in accordance with an x86 architecture, such as is available from INTEL CORPORATION of Mountain View, Calif. and others. In some embodiments, the processor 1402 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1404 include a random access memory (“RAM”) 1414, a read-only memory (“ROM”) 1416, an integrated storage memory (“integrated storage”) 1418, and a removable storage memory (“removable storage”) 1420. In some embodiments, the RAM 1414 or a portion thereof, the ROM 1416 or a portion thereof, and/or some combination the RAM 1414 and the ROM 1416 is integrated in the processor 1402. In some embodiments, the ROM 1416 is configured to store a firmware, an operating system or a portion thereof (e.g., operating system kernel), and/or a bootloader to load an operating system kernel from the integrated storage 1418 or the removable storage 1420.

The integrated storage 1418 can include a solid-state memory, a hard disk, or a combination of solid-state memory and a hard disk. The integrated storage 1418 may be soldered or otherwise connected to a logic board upon which the processor 1402 and other components described herein also may be connected. As such, the integrated storage 1418 is integrated in the computing device. The integrated storage 1418 is configured to store an operating system or portions thereof, application programs, data, and other software components described herein.

The removable storage 1420 can include a solid-state memory, a hard disk, or a combination of solid-state memory and a hard disk. In some embodiments, the removable storage 1420 is provided in lieu of the integrated storage 1418. In other embodiments, the removable storage 1420 is provided as additional optional storage. In some embodiments, the removable storage 1420 is logically combined with the integrated storage 1418 such that the total available storage is made available and shown to a user as a total combined capacity of the integrated storage 1418 and the removable storage 1420.

The removable storage 1420 is configured to be inserted into a removable storage memory slot (not shown) or other mechanism by which the removable storage 1420 is inserted and secured to facilitate a connection over which the removable storage 1420 can communicate with other components of the computing device, such as the processor 1402. The removable storage 1420 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1404 can store an operating system. According to various embodiments, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1406 include a wireless wide area network component (“WWAN component”) 1422, a wireless local area network component (“WLAN component”) 1424, and a wireless personal area network component (“WPAN component”) 1426. The network connectivity components 1406 facilitate communications to and from a network 108, which may be a WWAN, a WLAN, or a WPAN. Although a single network 108 is illustrated, the network connectivity components 1406 may facilitate simultaneous communication with multiple networks. For example, the network connectivity components 1406 may facilitate simultaneous communications with multiple networks via one or more of a WWAN, a WLAN, or a WPAN.

The network 108 may be a WWAN, such as a mobile telecommunications network utilizing one or more mobile telecommunications technologies to provide voice and/or data services to a computing device utilizing the computing device architecture 1400 via the WWAN component 1422. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 108 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 108 may be configured to provide voice and/or data communications with any combination of the above technologies. The network 108 may be configured to or adapted to provide voice and/or data communications in accordance with future generation technologies.

In some embodiments, the WWAN component 1422 is configured to provide dual-multi-mode connectivity to the network 108. For example, the WWAN component 1422 may be configured to provide connectivity to the network 108, wherein the network 108 provides service via GSM and UMTS technologies, or via some other combination of technologies. Alternatively, multiple WWAN components 1422 may be utilized to perform such functionality, and/or provide additional functionality to support other non-compatible technologies (i.e., incapable of being supported by a single WWAN component). The WWAN component 1422 may facilitate similar connectivity to multiple networks (e.g., a UMTS network and an LTE network).

The network 108 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a WI-FI hotspot. The WLAN component 1424 is configured to connect to the network 108 via the WI-FI access points. Such connections may be secured via various encryption technologies including, but not limited, WI-FI Protected Access (“WPA”), WPA2, Wired Equivalent Privacy (“WEP”), and the like.

The network 108 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 1426 is configured to facilitate communications with other devices, such as peripherals, computers, or other computing devices via the WPAN.

The sensor components 1408 include a magnetometer 1428, an ambient light sensor 1430, a proximity sensor 1432, an accelerometer 1434, a gyroscope 1436, and a Global Positioning System sensor (“GPS sensor”) 1438. It is contemplated that other sensors, such as, but not limited to, temperature sensors or shock detection sensors, also may be incorporated in the computing device architecture 1400.

The magnetometer 1428 is configured to measure the strength and direction of a magnetic field. In some embodiments the magnetometer 1428 provides measurements to a compass application program stored within one of the memory components 1404 in order to provide a user with accurate directions in a frame of reference including the cardinal directions, north, south, east, and west. Similar measurements may be provided to a navigation application program that includes a compass component. Other uses of measurements obtained by the magnetometer 1428 are contemplated.

The ambient light sensor 1430 is configured to measure ambient light. In some embodiments, the ambient light sensor 1430 provides measurements to an application program stored within one the memory components 1404 in order to automatically adjust the brightness of a display (described below) to compensate for low-light and high-light environments. Other uses of measurements obtained by the ambient light sensor 1430 are contemplated.

The proximity sensor 1432 is configured to detect the presence of an object or thing in proximity to the computing device without direct contact. In some embodiments, the proximity sensor 1432 detects the presence of a user's body (e.g., the user's face) and provides this information to an application program stored within one of the memory components 1404 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1428 are contemplated.

The accelerometer 1434 is configured to measure proper acceleration. In some embodiments, output from the accelerometer 1434 is used by an application program as an input mechanism to control some functionality of the application program. For example, the application program may be a video game in which a character, a portion thereof, or an object is moved or otherwise manipulated in response to input received via the accelerometer 1434. In some embodiments, output from the accelerometer 1434 is provided to an application program for use in switching between landscape and portrait modes, calculating coordinate acceleration, or detecting a fall. Other uses of the accelerometer 1434 are contemplated.

The gyroscope 1436 is configured to measure and maintain orientation. In some embodiments, output from the gyroscope 1436 is used by an application program as an input mechanism to control some functionality of the application program. For example, the gyroscope 1436 can be used for accurate recognition of movement within a 3D environment of a video game application or some other application. In some embodiments, an application program utilizes output from the gyroscope 1436 and the accelerometer 1434 to enhance control of some functionality of the application program. Other uses of the gyroscope 1436 are contemplated.

The GPS sensor 1438 is configured to receive signals from GPS satellites for use in calculating a location. The location calculated by the GPS sensor 1438 may be used by any application program that requires or benefits from location information. For example, the location calculated by the GPS sensor 1438 may be used with a navigation application program to provide directions from the location to a destination or directions from the destination to the location. Moreover, the GPS sensor 1438 may be used to provide location information to an external location-based service, such as E911 service. The GPS sensor 1438 may obtain location information generated via WI-FI, WIMAX, and/or cellular triangulation techniques utilizing one or more of the network connectivity components 1406 to aid the GPS sensor 1438 in obtaining a location fix. The GPS sensor 1438 may also be used in Assisted GPS (“A-GPS”) systems.

The I/O components 1410 include a display 1440, a touchscreen 1442, a data I/O interface component (“data I/O”) 1444, an audio I/O interface component (“audio I/O”) 1446, a video I/O interface component (“video I/O”) 1448, and a camera 1450. In some embodiments, the display 1440 and the touchscreen 1442 are combined. In some embodiments two or more of the data I/O component 1444, the audio I/O component 1446, and the video I/O component 1448 are combined. The I/O components 1410 may include discrete processors configured to support the various interface described below, or may include processing functionality built-in to the processor 1402.

The display 1440 is an output device configured to present information in a visual form. In particular, the display 1440 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some embodiments, the display 1440 is a liquid crystal display (“LCD”) utilizing any active or passive matrix technology and any backlighting technology (if used). In some embodiments, the display 1440 is an organic light emitting diode (“OLED”) display. Other display types are contemplated.

The touchscreen 1442 is an input device configured to detect the presence and location of a touch. The touchscreen 1442 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 1442 is incorporated on top of the display 1440 as a transparent layer to enable a user to use one or more touches to interact with objects or other information presented on the display 1440. In other embodiments, the touchscreen 1442 is a touch pad incorporated on a surface of the computing device that does not include the display 1440. For example, the computing device may have a touchscreen incorporated on top of the display 1440 and a touch pad on a surface opposite the display 1440.

In some embodiments, the touchscreen 1442 is a single-touch touchscreen. In other embodiments, the touchscreen 1442 is a multi-touch touchscreen. In some embodiments, the touchscreen 1442 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1442. As such, a developer may create gestures that are specific to a particular application program.

In some embodiments, the touchscreen 1442 supports a tap gesture in which a user taps the touchscreen 1442 once on an item presented on the display 1440. The tap gesture may be used for various reasons including, but not limited to, opening or launching whatever the user taps. For instance, items 604 in the user interface 602 may be tapped in one embodiment to open an associated file in a productivity application 110. In some embodiments, the touchscreen 1442 supports a double tap gesture in which a user taps the touchscreen 1442 twice on an item presented on the display 1440. The double tap gesture may be used for various reasons including, but not limited to, zooming in or zooming out in stages. In some embodiments, the touchscreen 1442 supports a tap and hold gesture in which a user taps the touchscreen 1442 and maintains contact for at least a pre-defined time. The tap and hold gesture may be used for various reasons including, but not limited to, opening a context-specific menu.

In some embodiments, the touchscreen 1442 supports a pan gesture in which a user places a finger on the touchscreen 1442 and maintains contact with the touchscreen 1442 while moving the finger on the touchscreen 1442. The pan gesture may be used for various reasons including, but not limited to, moving through screens, images, or menus at a controlled rate. For instance, such a gesture might be utilized to scroll through the items in the user interface 602. Multiple finger pan gestures are also contemplated. In some embodiments, the touchscreen 1442 supports a flick gesture in which a user swipes a finger in the direction the user wants the screen to move. The flick gesture may be used for various reasons including, but not limited to, scrolling horizontally or vertically through menus or pages. In some embodiments, the touchscreen 1442 supports a pinch and stretch gesture in which a user makes a pinching motion with two fingers (e.g., thumb and forefinger) on the touchscreen 1442 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 1442. As such, the above gestures should be understood as being illustrative and should not be construed as being limiting in any way. The various gestures described above, and others, might be utilized in embodiments to interact with the user interface 602 described above.

The data I/O interface component 1444 is configured to facilitate input of data to the computing device and output of data from the computing device. In some embodiments, the data I/O interface component 1444 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 1446 is configured to provide audio input and/or output capabilities to the computing device. In some embodiments, the audio I/O interface component 1444 includes a microphone configured to collect audio signals. In some embodiments, the audio I/O interface component 1444 includes a headphone jack configured to provide connectivity for headphones or other external speakers. In some embodiments, the audio interface component 1446 includes a speaker for the output of audio signals. In some embodiments, the audio I/O interface component 1444 includes an optical audio cable out.

The video I/O interface component 1448 is configured to provide video input and/or output capabilities to the computing device. In some embodiments, the video I/O interface component 1448 includes a video connector configured to receive video as input from another device (e.g., a video media player such as a DVD or BLURAY player) or send video as output to another device (e.g., a monitor, a television, or some other external display). In some embodiments, the video I/O interface component 1448 includes a High-Definition Multimedia Interface (“HDMI”), mini-HDMI, micro-HDMI, DisplayPort, or proprietary connector to input/output video content. In some embodiments, the video I/O interface component 1448 or portions thereof is combined with the audio I/O interface component 1446 or portions thereof.

The camera 1450 can be configured to capture still images and/or video. The camera 1450 may utilize a charge coupled device (“CCD”) or a complementary metal oxide semiconductor (“CMOS”) image sensor to capture images. In some embodiments, the camera 1450 includes a flash to aid in taking pictures in low-light environments. Settings for the camera 1450 may be implemented as hardware or software buttons.

Although not illustrated, one or more hardware buttons may also be included in the computing device architecture 1400. The hardware buttons may be used for controlling some operational aspect of the computing device. The hardware buttons may be dedicated buttons or multi-use buttons. The hardware buttons may be mechanical or sensor-based.

The illustrated power components 1412 include one or more batteries 1452, which can be connected to a battery gauge 1454. The batteries 1452 may be rechargeable or disposable. Rechargeable battery types include, but are not limited to, lithium polymer, lithium ion, nickel cadmium, and nickel metal hydride. Each of the batteries 1452 may be made of one or more cells.

The battery gauge 1454 can be configured to measure battery parameters such as current, voltage, and temperature. In some embodiments, the battery gauge 1454 is configured to measure the effect of a battery's discharge rate, temperature, age and other factors to predict remaining life within a certain percentage of error. In some embodiments, the battery gauge 1454 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 1412 may also include a power connector, which may be combined with one or more of the aforementioned I/O components 1410. The power components 1412 may interface with an external power system or charging equipment via a power I/O component 1442.

Based on the foregoing, it should be appreciated that technologies for providing a global recently used files list are provided herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing a global recently used files list, the method comprising performing computer-implemented operations for:
generating a global recently used files list that identifies one or more files recently accessed by way of one or more network services and one or more files recently accessed locally on a computing device; and
displaying a user interface for presenting the list.

2. The computer-implemented method of claim 1, wherein generating the global recently used files list comprises:
retrieving a network recently used files list that identifies the one or more files recently accessed by way of the one or more network services; and
merging the network recently used files list with a local recently used files list that identifies the one or more files recently accessed locally on the computing device to generate the global recently used files list.

3. The computer-implemented method of claim 2, further comprising:
receiving a request by way of the user interface to access a selected one of the files identified in the global recently used files list; and
performing the requested access in response to receiving the request.

4. The computer-implemented method of claim 3, further comprising in response to receiving the request:
updating the network recently used files list to indicate the access to the selected one of the files if the selected one of the files was previously accessed by way of one or more network services.

5. The computer-implemented method of claim 4, further comprising in response to receiving the request:
updating the local recently used files list to indicate the access to the selected one of the files if the selected one of the files was previously accessed locally on the computing device.

6. The computer-implemented method of claim 5, wherein the requested access comprises a request to open the file, download the file to the computing device, save the file to a new location, share the file, pin the file, or remove the file from the global recently used files list.

7. The computer-implemented method of claim 6, wherein the user interface comprises items corresponding to the files identified in the global recently used files list, each item indicating the name of a file identified in the global recently used files list, an indication of the location of the file, and an icon indicating a type of the file.

8. The computer-implemented method of claim 7, wherein the user interface further comprises a status indicator for showing a status of an operation for retrieving the network recently used files list.

9. A computer storage medium having computer executable instructions stored thereon which, when executed by a computer, cause the computer to:
retrieve from a network location one or more network recently used files lists that identify one or more files that have been recently accessed by one or more applications through one or more network services;
maintain at a computing device one or more local recently used files lists that identify one or more files that are stored on the computing device and that have been recently accessed by one or more applications executing on the computing device;
generate a global recently used files list by merging the one or more network recently used files lists and the one or more local recently used files lists; and
presenting a user interface on the computing device for displaying the global recently used files list.

10. The computer storage medium of claim 9, having further computer executable instructions stored thereon which, when executed by the computer, cause the computer to update at least one of the network recently used files lists in response to determining that one of the one or more applications have accessed a file through one of the one or more network services.

11. The computer storage medium of claim 10, having further computer executable instructions stored thereon which, when executed by the computer, cause the computer to update at least one of the one or more local recently used files lists in response to determining that the one or more applications executing on the computing device have accessed a file stored on the computing device.

12. The computer storage medium of claim 11, wherein the user interface comprises items corresponding to the files identified in the global recently used files list, each item indicating the name of a file identified in the global recently used files list, an indication of the location of the file or a device on which the file was last opened, and an icon indicating a type of the file.

13. The computer storage medium of claim 12, wherein the user interface further comprises a status indicator for showing a status of an operation for retrieving the network recently used files list.

14. The computer storage medium of claim 13, wherein each item in the user interface in the global recently used files list can be selected in order to open associated file in an application program.

15. The computer storage medium of claim 16, wherein the user interface further comprises a user interface control for downloading a file, saving a file to a new location, sharing a file, pinning a file, or removing a file from the global recently used files list.

16. The computer storage medium of claim 15, where in the user interface is optimized for presentation on a display screen in a smart phone or tablet computing device.

17. A computing device configured to provide a global recently used files list, the computing device comprising:
a processor; and
a computer storage medium having computer executable instructions stored thereon which, when executed by the processor, cause the computing device to
retrieve from a network location one or more network recently used files lists that identify one or more files that have been recently accessed by applications executing on a plurality of computing devices through one or more network services,
maintain on the computer storage medium one or more local recently used files lists that identify one or more files that are stored on the computer storage medium and that have been recently accessed by applications executing on the computing device,
generate a global recently used files list on the computing device from the one or more network recently used files lists and the one or more local recently used files lists, and
presenting a user interface on the computing device for displaying the global recently used files list.

18. The computing device of claim 17, wherein the computer storage medium has further computer executable instructions stored thereupon which, when executed by the processor, cause the computing device to update at least one of the network recently used file lists in response to an application executing on the computing device accessing a file through one or more of the network services.

19. The computing device of claim 18, wherein accessing a file comprises opening a file, downloading a file, saving a file to a new location, sharing a file, pinning a file, or removing a file from the global recently used files list.

20. The computing device of claim 19, wherein the computer storage medium has further computer executable instructions stored thereupon which, when executed by the processor, cause the computing device to update at least one of the local recently used file lists in response to an application executing on the computing device accessing a file stored on the computer storage medium.
